(19) United States
(12) Patent Application Publication
(10) Pub. No.: US 2022/0397480 A1
(43) Pub. Date: Dec. 15, 2022

(54) FLUID DRAG MEASURING METHOD AND DEVICE

(71) Applicant: Dimple IP B.V., Utrecht (NL)

(72) Inventors: Olaf VAN CAMPENHOUT, Utrecht (NL); Michiel VAN NESSELROOIJ, Utrecht (NL)

(21) Appl. No.: 17/716,091

(22) PCT Filed: Oct. 9, 2020
(86) PCT No.: PCT/EP2020/078436

§ 371 Date: Apr. 8, 2022

(30) Foreign Application Priority Data
Oct. 10, 2019 (NL) 2023990

(51) Int. Cl. G01M 9/06

(52) U.S. Cl. CPC G01M 9/065; G01M 9/062

(57) ABSTRACT

Method and device for measuring fluid drag exerted by a flow-medium on a surface of an object by providing a testing device for measuring fluid drag exerted by a flow-medium on a surface, a suspension system for suspending an object having a surface, a setup for measuring fluid drag exerted by a flow-medium on a surface of an object, a computer readable medium, and a kit of parts for building a testing device.

### FIELD OF THE INVENTION

The invention relates generally to a method for measuring fluid drag exerted by a flow-medium on a surface of an object and more particularly to a testing device for measuring fluid drag exerted by a flow-medium on a surface, a suspension system for suspending an object having a surface, a setup for measuring fluid drag exerted by a flow-medium on a surface of an object, a computer readable medium, and a kit of parts for building a testing device.

### BACKGROUND OF THE INVENTION

There is a general and ongoing need to improve the energy efficiency involved in the movement of objects through fluid media, or of fluid media through or past solid objects. For example, it is a continuous desire to improve the efficiency with which vehicles are displaced through fluid media, especially airplanes or land-vehicles through air or ships through water. It is also desirable to improve the efficiency of with which fluids can be transported past surfaces, for example liquids (oil, water etc.) or gases (natural gas etc.) through pipelines, especially over long distances, at high pressures and at high flow speeds.

Various attempts have been made to address this desire for improved fluid dynamic efficiency. However, the ability to research and achieve improvements can often be restricted by difficulties and costs involved in the testing of novel and non-conventional concepts of surface design. In particular, fluid dynamics test facilities, such as wind tunnels, often offer only a limited range of (readily carried out) testing, absent major, expensive and possibly permanent structural alteration of such facilities. This limiting factor can slow the rate at which progress is made in finding efficiency improvements.

A number of attempts to measure force components exerted upon objects in a wind tunnels have been described in the art, as follows.

Document U.S. Pat. No. 4,112,752 discloses an apparatus for measuring force components exerted by a flowing medium such as air in a wind tunnel upon an object to be measured. The object is rigidly attached to a carrier. A first force measuring device connected between the object carrier and a first bearing guide member restrains movement of the object carrier. The measuring apparatus requires a large space beneath the floor of a measuring chamber to operate. The determined force is indicative of total fluid drag on the object.

Document U.S. Pat. No. 4,240,290 discloses a skin friction measuring device for measuring the resistance of an aerodynamic surface to an airstream, adapted to be mounted on an aircraft, with an opening defined therein, and characterized by a friction plate adapted to be disposed in a flush relationship with the external surface of the aircraft and be displaced in response to skin-friction drag, as an airstream is caused to flow over the surface thereof. A potentiometer connected to the plate provides an electrical output indicative of the magnitude of the drag. The potentiometer connected to the plate measures a distance against a predetermined resistance. Since the friction plate is disposed in a flush relationship with the external surface of the aircraft, there is a need for an opening in the aircraft surface. Likewise, upon application in a measurement chamber, said opening is also required to achieve a flush relationship between the friction plate and a surface of the measurement chamber, leading the measurement chamber to be modified based on the geometry of the friction plate.

The known state of the art for determining fluid drag on a surface, in particular skin friction, is thus to create a large opening or recess in a wall of a measurement chamber and dispose a surface to be measured in the opening created in the wall of the measurement chamber. All measurement equipment is disposed on the rear side of the wall of the measurement chamber relative to the flow-medium. Having an opening in the measuring chamber severely affects the flexibility and employability for testing fluid drag on surfaces. Even if a measurement chamber is adapted in a way to allow testing of fluid drag on a surface i.e., by provision of an opening or recess in one of its walls, so that a surface can be laid flush with the tunnel floor or wall, it remains complex to measure surfaces having different geometries, in particular of varying dimensions, as may be necessary to determine flow over extended surface lengths, let alone measuring surfaces in different measuring chambers.

There is a need for improved methods and apparatuses for measuring fluid drag exerted by a flow-medium on a surface of an object.

### BRIEF SUMMARY OF THE INVENTION

In one aspect of the invention there is provided a method for measuring fluid drag exerted by a flow-medium on a surface of an object, the fluid drag being the result of movement of the flow-medium along said surface, the method comprising the steps of: suspending the object within a measurement chamber, and at a distance from a base surface of the measurement chamber; providing a boundary layer of a flowing medium over the surface; and measuring at least one force resulting from the fluid drag.

Fluid drag is understood to refer to force exerted on a solid object as a result of the movement of a flow-medium relative to the object. Fluid drag can comprise skin friction, pressure drag, induced drag, and wave drag. In an embodiment of the invention, the fluid drag that is measured is substantially completely skin friction. Since the drag is exerted on the object as a result of the relative movement of the flow-medium and the object, the flow-medium may move, the surface may move, possibly together with the testing device, or both the flow-medium and the surface may move.

The flow-medium is preferably a liquid flow or a gas flow or a combination thereof. Fluid is, however, the overarching term for anything that flows, for example liquids; gases; aerosols; gels; solutions; powders; suspensions.

By providing the test-surface at a distance from the base surface (e.g. wall, floor, or ceiling) of the measurement chamber, and by providing the boundary at that distanced level or position of the test-surface, a surface can be tested in various measurement chambers, without any need to provide major, permanent and possibly detrimental alterations to the surfaces of each of the measurement chambers, e.g. the provision of openings or recesses in the walls, floor or ceiling. As discussed in further detail herein, in preferred embodiments a ramp or a splitter may be used to provide the boundary layer at the appropriate position.

According to a preferred embodiment, the step of measuring the forces resulting from the fluid drag may further comprise receiving data from one or more sensors and processing that data.

The method may further comprise receiving data from at least one pressure sensor. In a preferred embodiment, the method further comprises the step of correcting the measurement based on the data from the at least one pressure sensor. These steps are preferably carried out after and/or during the step of diverting a boundary layer to the level of the surface,

The object to be tested may be a plate, a sheet, or substantially plate-shaped, having a surface to be tested for fluid drag. Alternatively, the object may be an object having a different shape. For example, the object may be convex or concave, or comprise a combination of convex an concave areas. For example, the object may be the door of an aircraft, having a curvature in its surface, or any other part of an aeroplane or other vehicle, shell. The object may further be provided with additional components of which the effects on fluid drag are to be tested.

In an embodiment, the fluid drag is composed of at least 20%, preferably at least 60%, more preferably at least 80% of skin friction. Having a larger percentage skin friction with reference to other types of drag allows for an increased accuracy when measuring the skin friction, as the influence of other types of friction is diminished.

The movement of a flow-medium relative to the object may result in a boundary layer at the surface of the object. The boundary layer may be a turbulent boundary layer; a laminar boundary layer; or a transitional boundary layer. The boundary layer may be attached; separated; or both.

The testing device and the surface in the testing device may be placed in and removed from the measurement chamber and used without making major and/or permanent alterations to a measurement chamber. The measurement chamber is preferably a wind-tunnel. The flow-medium may be a gas, preferably air. Alternatively, the flow-medium may be a liquid, preferably water for testing ship hulls, or oil or water for testing pipelines. In a preferred embodiment, the testing device is able to withstand a flow velocity of at least Mach 0.1, preferably at least Mach 0.5, more preferably at least Mach 1.

In another aspect of the invention there is provided a testing device for measuring fluid drag exerted by a flow-medium on a surface, the testing device comprising: a body for retaining a surface to be tested; one or more sensors, arranged to measure force exerted on the surface; and a flow diverter.

In an embodiment, the body of the testing device has a recess for receiving an object having the surface, wherein preferably the object is provided in the recess of the body. The recess has a depth allowing the surface to be substantially aligned with the sides of the body so that vortices at the edges of the surface are limited. The body is preferably held in the recess so that it is flush, allowing flow of the provided boundary layer over the surface to be tested.

That is, the edges of the surface and the sides of the body are substantially flush, thereby limiting the effect of the edge on the airflow. This leaves the boundary layer in a measuring chamber substantially unaffected. As a result, fluid drag on the surface can be accurately determined.

In an embodiment, the body may further comprise a front, two sides and a rear, wherein the front of the body is positioned so that it is upstream compared to the rear of the body when the flow-medium flows over the body. The body of the testing device may be substantially cuboid so that a substantially rectangular sheet or plate may be received in the recess.

The shape of the surface may be substantially planar in one embodiment. Alternatively, the shape of the surface may be curved, being convex, concave or a combination of both.

The flow-medium may be at about ambient conditions. Ambient conditions are understood to be common, prevailing and uncontrolled atmospheric conditions in a room or a place. As a result, the flow-medium being at about ambient conditions is meant to take into account any uncontrollable variations in the pressure, humidity, temperature and/or other relevant characteristics. The testing device may preferably be used with air as the flow medium.

In an embodiment, the height of the body is at most about 20%, preferably at most about 10%, more preferably at most about 5%, even more preferably at most about 3% of the length of the body. The limited ratio between the body height and body length leads to a slender testing device which does not perturb the flow substantially. Thereby, the entire testing device can be placed inside the measuring chamber (for example a wind tunnel test section) and therefore the testing device is measurement chamber-generic (i.e. it can be used in multiple wind tunnels). This is an important advantage as it diminishes the need for developing a new testing device for every individual measuring chamber, or the detrimental need to cut large opening(s) in the wall of a measuring chamber.

The height of the body is not necessarily constant across the length or the width of the body. For example, the height of the body may decrease over a length direction (the flow direction) of the testing device to provide a slanted recess for the object. If the height is not constant over the length or width of the body, the average height over the distance will be used to determine the relationship with its length as explained above.

In an embodiment, the testing device has a length in the direction of the movement of the flow-medium, wherein the length of the testing device is less than about 5 meters, preferably less than about 3 meters, more preferably less than about 2 meters. The width of the testing device may be less than about 1.5 meters, preferably less than about 1 meter, more preferably less than about 0.5 meter.

The body may further comprise a support plate disposed within the body arranged to support the object comprising the measured surface when placed in the body. The object can be placed on the support plate, the support plate being the interface between the object and various delicate measuring equipment. Having a support plate which interacts with the measuring equipment reduces the risk of damage to fragile components within the testing device, while allowing for easy and swift replacement of the object in the testing device.

In an embodiment, the testing device further comprises a flow-medium velocity sensor. In a preferred embodiment, the velocity sensor preferably is moveable in a direction perpendicular to the surface, thereby allowing for accurate measurements across the thickness of the boundary layer. By having a velocity sensor moveable in a direction perpendicular to the surface, the boundary layer can be characterized over multiple points, providing additional repeatability in the acquisition of data.

The testing device may further comprise a stanchion, possibly in a periscope form, said stanchion being attached to the upper side of the body. In an embodiment, the velocity sensor may be attached to the stanchion. The stanchion may allow the velocity sensor to be effectively attached to the testing device while also allowing movement of the velocity sensor in a direction perpendicular to the surface. The velocity sensor may be moveable along the stanchion, substantially perpendicular to the support plate, and preferably to the surface. Characteristics of the fluid flow at various distances from the surface in that manner can be determined. Alternatively, the velocity sensor may be otherwise attached to the body of the testing device, said velocity sensor being moveable along the thickness of the boundary layer.

The velocity sensor may extend substantially parallel over the surface. In a preferred embodiment, the velocity sensor extends from the stanchion in an upstream direction over the surface. The velocity sensor may be a hotwire running from a point near the rear of the body, for example the stanchion, towards the front of the body over at least a part of the surface. Preferably, the velocity sensor extends in parallel to the direction of the flow-medium when the testing device is in use.

The testing device may further comprise a pressure sensor positioned over the body, wherein the pressure sensor preferably comprises a pitot tube. The pressure sensor may be attached to the stanchion. Due to the pitot tube, which may be included in the device, the testing device can perform all measurements required and there is no sensor input required from the wind tunnel. This increases the flexibility of the device and can help to ensure that data is always captured with the same sensor across multiple measuring chambers, such as different wind tunnels, thereby improving repeatability and thus measurement accuracy.

In an embodiment, the testing device may comprise one or more force sensors attached to the body and arranged to directly or indirectly engage with the object when the object is disposed in the body. The support plate or the object may comprise one or more pins, arranged to engage with the one or more force sensors. In an embodiment, at least two force sensors are connected to the body. The disposition of at least two force sensors allows for accurate measurement of a moment applied to the surface of the object by fluid drag to be measured, while still optionally utilizing linear force measurement devices. If the surface of a single object is divided into two parts, each having a different surface texture, and thus different resulting drags, the drag forces will exert a moment on the object, which is measurable by determining the difference between the forces exerted on the at least two force sensors, taking into account their position relative to the surface of the object.

The testing device may further comprise a processing unit, wherein the force sensors transmit data to the processing unit. The processing unit then uses the data from the force sensors to determine the fluid drag exerted by the flow-medium on the surface of the object.

In an embodiment, the testing device further comprises at least one interbody-surface pressure sensor disposed between the surface and the body for determining parasitic drag, wherein preferably the testing device comprises at least 3, preferably at least 5, more preferably at least 10, even more preferably at least 20 interbody-surface pressure sensors, arranged to measure a pressure profile between the support plate and the body or between the surface and the body. The pressure sensors allow for the calculation of the parasitic drag on the surface due to a pressure differential within the cavity between the surface and the body front, and/or the body rear, and/or at least one of the body sides. The resulting data can be corrected for the parasitic drag and hence the final fluid drag measurements are more accurate.

In a preferred embodiment, the testing device is able to measure forces between 0.1N-100N exerted on the surface due to fluid drag, preferably with a repeatability which is smaller than about 4%, preferably smaller than about 1%, more preferably smaller than about 0.3%.

In an embodiment, a flow diverter is provided in the form of a ramp, having a ramp top surface arranged to guide the flow-medium from a base surface (e.g. wall, floor or ceiling) of the measurement chamber to the test-surface of the object. The ramp ensures that a boundary layer arrives at the surface of the object which corresponds to the boundary layer in the measurement chamber upstream from the testing device. The ramp may preferably have a ramp rear having a height corresponding with the body height. As a result, the boundary layer is directed from the ramp onto the surface while keeping influences of the testing device to the boundary layer minimal. In a preferred embodiment, in a cross-section of the ramp, parallel to the direction of movement of the flow-medium and parallel to the direction of gravity, the ramp top surface of the ramp defines, at least partially, a super-ellipse in said cross-section. The super-elliptical shape of the cross-section minimizes perturbations to the flow by the ramp. The ramp may be attached to the body or may be positioned adjacent to the body. In an alternative embodiment, the ramp may be integrally formed with the body of the testing device.

In another embodiment, the flow diverter may be a splitter (e.g. an air-splitter) having an elevated front edge, a splitter rear and a splitter surface, the splitter surface being substantially parallel to the surface of the object. The splitter creates a new boundary layer that passes over the testing device, and hence increases the flexibility and employability of the device. The splitter rear may be at a height corresponding with the body height and may be attached to the body.

The flow diverter of the invention may take the form of a splitter, a ramp or a combination of both.

In an embodiment, the body further comprises body sides, and the testing device further comprises at least one lateral flow guide having a side ramp top surface arranged to decrease fluctuations of the boundary layer at the region of the body sides. The lateral flow guide may have a free ramp side and a connection ramp side. The connection ramp side of the lateral flow guide may have a height corresponding to the body height and may be attached to the body or positioned adjacent to the body side. Alternatively, the at least one lateral flow guide may be integrally formed with the body.

In an embodiment, the ramp has a top surface arranged to guide the flow-medium from a base surface to the surface of the object, wherein the ramp preferably has a ramp rear having a height corresponding with the body height, wherein more preferably, in a cross-section of the ramp, parallel to the direction of movement of the flow-medium and parallel to the direction of gravity, the ramp top surface of the ramp defines, at least partially, a super-ellipse in said cross-section.

In an embodiment, the body further comprises a body rear, and the testing device further comprises a body-extension arranged to support the air-flow once it has passed over the surface of the object. The body-extension may reduce effects of the instability of the boundary layer to the measurement accuracy by extending the boundary layer at the level of the surface further than the body rear. The body-extension may be positioned adjacent to the body rear, or may be connected to the body rear. Alternatively, the body-extension may be integrally formed with the body.

In an embodiment wherein the flow diverter and/or the lateral flow-guide and/or the body extension are integrally formed with the body, the body and its recess may be defined by the flow diverter and/or the lateral flow-guide and/or the body extension.

The testing device may further comprise an anchoring unit, said anchoring unit being connected to the underside of the body, said anchoring unit being arranged to limit the movement of the body relative to a wall of a measuring chamber. The anchoring unit may be arranged to traverse through an opening in the measuring chamber to attach the underside of the body to said wall. The anchoring unit may comprise a data transportation unit for the transfer of data generated by the sensors from the testing device to an external reading device. Further, the anchoring unit may comprise a gasket to seal the opening in the wall of the measuring chamber. Having a gasket to seal the opening in the wall of the wind tunnel has a positive effect on the stability of the pressure in the wind-tunnel. Especially when running at high speeds, the pressure in the wind-tunnel may be relatively high. By sealing the wind-tunnel with a gasket attached to the anchoring unit, the stability of the testing device as well as stability of the pressure inside the measuring chamber are ensured.

The testing device may further comprise one or more vibration damping supports, arranged to attach the anchoring unit to the wall of the measuring chamber. The one or more vibration damping supports may be active damping devices. Alternatively, the one or more vibration damping supports may be passive damping devices. By providing one or more vibration damping supports to attach the anchoring unit to the wall of the measuring chamber, disadvantageous vibrations of the measuring chamber can be largely eliminated.

In an embodiment, the body comprises one or more ejectors, arranged to displace (e.g. lift) the object. When the object must be removed from the body, the ejectors push out the object so that it can easily be grasped by the user. The one or more ejectors may be pneumatic, or electronic, or hydraulic. The ejectors allow for the test plate to be removed, inserted, and aligned by means of an automated system. Due to the fact that this is done automatically, the interference of the wind tunnel operator is minimized and the repeatability of the system is improved. In another embodiment, it may be possible that the ejectors are also or exclusively arranged to engage with the support plate to lift the support plate.

In an embodiment, the support plate may comprise a locking system, wherein the object comprises a lock attachment, the lock attachment being arranged to engage with the locking system to secure the object to the support plate. The plate locking system is a safety feature that allows to lock the surface in the device while minimizing the perturbation to the flow due to the fact that the locking is performed from the side which is not in contact with the flow-medium.

The lock attachment may be a ring, and the locking system may comprise a conic member arranged to protrude at least partially through the ring and securing the object to the support plate. The locking system may be electrically actuated. The locking system may be in an extended position to engage with the lock attachment when no power is supplied to the locking system. The locking system may be arranged to retract, allowing the lock attachment to be released, when the locking system is powered. By limiting the power supplied to the system when the support plate is engaged with the object, the influences of electrical signals are severely limited. Given the accuracy of the measurement equipment, the influence of inductance from an electrical circuit could be detrimental to the measurement abilities of the testing device. Since the engaged position of the locking system requires no electrical power, this effect is eliminated, thereby increasing measurement accuracy.

The testing device may further comprise an suspension system arranged to suspend the surface for measuring fluid drag exerted on the surface by the flow-medium. The suspension system may allow movement in a first direction and limit movement in a second direction. The first direction may coincide with the direction of movement of the flow-medium and the second direction may be perpendicular to the direction of movement of the flow-medium. The first direction may coincide with the direction of movement of the flow-medium and the second direction may coincide with the direction of gravity. In some embodiments, the suspension system may be an elevation system.

In a preferred embodiment, the suspension system comprises at least one leaf spring system comprising a support body and a static body, the support body and the static body being connected via at least one leaf spring. The static body may be connected to the body of the testing device and the support body may directly or indirectly support the surface. The at least one leaf spring of this embodiment ensures the limitation of movement in one direction, said direction being parallel to the plane of the leaf spring. The leaf spring allows for movement in a second direction, perpendicular to the plane of the leaf spring. This ensures substantially resistance-free movement in the direction of the flow of the flow-medium.

The suspension system may limit rotational movement of the surface along any axis perpendicular to the flow direction, allowing for rotation about the flow direction of the flow-medium. The suspension system may limit rotational movement induced by a moment on the surface of the object.

In an embodiment, the static body may partially or substantially or completely surround the support body. The static body and the support body may be connected by at least one leaf spring, connecting one side of the static body with one side of the support body. Alternatively, the static body and the support body may be connected by two or more leaf springs, connecting one side of the static body with one side of the support body.

In an embodiment, the testing device may comprise at most 20, preferably at most 10, more preferably at most 3, still more preferably 1 leaf spring systems, wherein preferably the leaf spring systems are disposed in the body to support an object or a support plate. Having multiple leaf spring systems to support the object having the surface or the support plate is disadvantageous due to the risk of over-constraining the supported unit. Since the leaf spring systems allow for one directional movement, while limiting other movements, aligning the leaf spring systems to a high accuracy is required to move the supported body as a whole. By providing a limited number of leaf spring systems, disadvantages of aligning the systems are reduced.

In an alternative embodiment, the suspension system may comprise one or more air bearings. Air bearings may comprise one or more orifices allowing air to be exerted therefrom at pressure sufficient to levitate the object or the support plate. The suspension system may comprise one or more air bearings comprising a porous surface. The air bearings may further comprise an axle, having the porous surface disposed therearound, the air pressure allowing for substantially resistance-free movement along said axle and around said axle. In an embodiment having two air bearings, the axles of which are disposed parallel to one another, the rotation of the object around said axles is prevented, thereby only allowing for resistance-free movement allow the axes of the air bearings.

Another aspect of the invention comprises an suspension system comprising at least one leaf spring system comprising a support body and a static body, the support body and the static body being connected with at least one leaf spring, arranged to allow movement in a first direction while limiting movement in a second direction. In a preferred embodiment, the first direction coincides with the direction of movement of a flow-medium and the second direction coincides with the direction of gravity. In an embodiment, the static body may be arranged to be connected to the body of the testing device and the support body directly or indirectly supports the surface.

In an embodiment, the static body and the support body are connected by at least one leaf spring, connecting one side of the static body with one side of the support body. In a preferred embodiment, the elevation system or suspension system couples an object having a surface and a transportation apparatus, wherein the surface of the object forms at least a section of a surface area of said transportation apparatus. The transportation apparatus may be any elongated means of transport such as a train, a ship, a pipe, or an aircraft. The surface of the object may form the surface of the door of an aircraft.

By providing a testing setup that may be readily attached to the surface of a vehicle or aircraft, the performance can be tested in a repeatable and efficient way. Furthermore, by providing an aircraft door with such a testing set-up, the testing device may be prefabricated in an easy manner, without having to alter surface properties of the aircraft itself, thereby providing advantages pertaining to safety and structural integrity of the aircraft.

Another aspect of the invention comprises a setup for measuring fluid drag exerted by a flow-medium on a surface of an object, the fluid drag being the result of movement of the flow-medium along a direction of the surface, the setup comprising: a testing device as described hereinbefore; and a chamber for supplying a controlled flow of a flow-medium, such as a wind tunnel. In an embodiment, the setup may further comprise a velocity sensor disposed in the measurement chamber, preferably attached to the testing device.

Another aspect of the invention comprises a computer readable medium having computer readable instruction stored thereon that, when executed by a processor of an apparatus as described hereinbefore causes the apparatus to measure forces exerted on a surface.

Another aspect of the invention comprises a kit of parts for building a testing device, comprising: a body; one or more force sensors; a flow-diverter; and a suspension system. All components of the kit of parts for building a testing device may be according to any of the descriptions as provided hereinbefore. Since the testing device may readily be placed inside existing measurement chambers, without the need for altering the measurement chambers, as is current common practice for measuring fluid drag, a kit of parts allows a user to easily transport and utilize the testing device.

In a preferred embodiment, the kit of parts further comprises; one or more pressure sensors; and/or a processing unit; and/or a flow-medium velocity sensor; and/or a pressure sensor, preferably a pitot tube. The kit of parts may have a weight of at most about 500 kg, preferably at most about 300 kg, more preferably at most about 100 kg, still more preferably at most about 50 kg.

### BRIEF DESCRIPTION OF THE DRAWINGS

The features and advantages of the invention will be appreciated upon reference to the following drawings, in which:

FIG. 1 is an isometric exploded view of one embodiment of the invention showing the testing device;

FIG. 2 is an isometric view of one embodiment of the invention showing the testing device;

FIG. 3 is a plan view of one embodiment of the invention showing the suspension system;

FIG. 4 is a flow chart illustrating a method for measuring fluid drag in some embodiments according to the present disclosure;

FIG. 5 is a schematic diagram illustrating the processing of measured parameters; and

FIG. 6 is a side view of one embodiment of the invention showing the testing device.

### DESCRIPTION OF ILLUSTRATIVE EMBODIMENTS

The following is a description of certain embodiments of the invention, given by way of example only and with reference to the drawings.

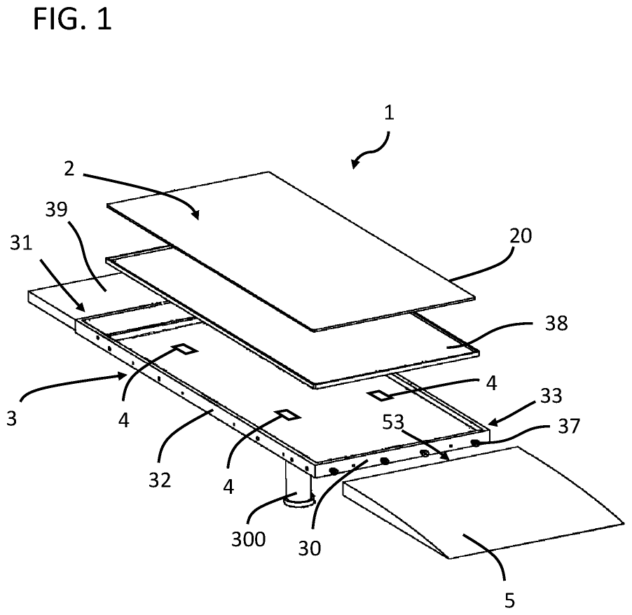

Referring to FIG. 1, a testing device 1 for measuring fluid drag exerted by a flow-medium on a surface 2 is shown. The testing device comprises a body 3 for retaining a surface 2 to be tested. The surface 2 is the top surface 2 of an object 20. The object 20 is a plate-shaped structure in the illustrated embodiment, the geometry of which is in accordance with the shape of the body 3 in such a way that the object 20 may closely be received in the recess defined by the body 3. The body 3 may have wider dimensions to minimize disturbances of the boundary layer. In the shown embodiment, the body 3 is substantially cuboid, having a body front 30, a body rear 31 and body sides 32, 33. The body 3 defines a recess for receiving the object 20 with the surface 2 therein. The flow-medium flows through the measuring chamber along the length of the body 3, between the body front 30 and the body rear 31. The body front 30 is positioned upstream from the body rear 31.

Force sensors 4 are disposed within the body 3 of the testing device 1 and are arranged to measure force exerted on the surface 2. The surface 2 to be tested exerts a force to the force sensors 4 in the flow-direction of the flow-medium. In the illustrated embodiment, the surface 2 exerts a force to the force sensors 4 in an indirect manner as the object 20 having the surface 2 is disposed on a support plate 38, which engages with the force sensors 4. The support plate 38 may be generally the same shape as the object 20 and with the body 3. The support plate 38 protects the internal components of the testing device 1 such as the force sensors 4, the electronics, and other delicate components of the testing device 1.

The testing device 1 in the illustration further comprises a flow diverter 5 positioned upstream of the body 3 which diverts a boundary layer from the floor 11 of the measuring chamber to the surface 2 of the object 20. The flow diverter 5 in this embodiment is a ramp 5, having a super-elliptical shape. The ramp 5 ensures that the boundary layer is diverted to the surface 2 while minimizing the effects of the diversion so that the boundary layer arriving at the surface 2 is substantially equal to the boundary layer on the floor 11 of the measurement chamber upstream from the testing device.

The ramp has a ramp rear 53 which corresponds to the body height as measured at the body front 30, so that the surface of the ramp 5 and the surface 2, when disposed in the recess of the body 3 are flush. The ramp 5 is shown separate from the body 3. The body front 30 comprises body attachment units 37, arranged to connect the body front 30 to the ramp 5. The attachment units 37 allow for easy connection between the body front 30 and the ramp 5. The attachment units 37 may also be positioned on the body sides 32, 33 for attachment of lateral flow guides and may be positioned on the body rear 31.

In this embodiment, the testing device 1 further comprises a body-extension 39, provided downstream from the body 3. The body-extension 39 is shown to be connected to the body rear 31 with body attachment units 37.

The testing device 1 is further shown to comprise an anchoring unit 300 being arranged to limit movement of the testing device 1 in the measurement chamber. The anchoring unit 300 is attached to the underside of the body 3 of the testing device 1 and may further allow for the transmittance of data through the anchoring unit 300, which may be partially hollowed in such an embodiment. The anchoring unit 300 may traverse through an opening 12 in the wall 11 or floor 11 of a measurement chamber.

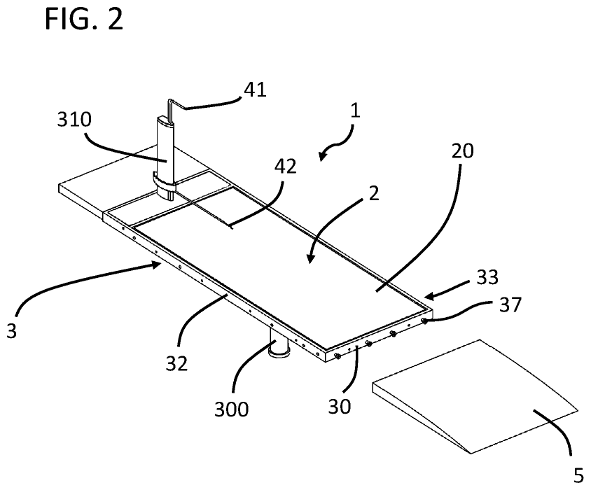

Referring to FIG. 2, a testing device 1 for measuring fluid drag exerted by a flow-medium on a surface 2 is shown. The object 20 having the surface 2 is disposed inside the recess of the body 3 of the testing device 1 in this illustration. In addition to the components shown in FIG. 1, the testing device 1 is shown to further comprise a stanchion 310 extending from a rear portion of the body 3 of the testing device 1. The stanchion 310 comprises a pressure sensor 41 and a velocity sensor 42. The pressure sensor 41 is positioned at the top of the stanchion and is arranged to determine the characteristics of the flow within the measurement chamber. The velocity sensor 42, in this embodiment depicted as a hotwire, extends substantially parallel to the surface 2 of the object 20 and is arranged to measure the velocity of the boundary layer at various points across the thickness of the boundary layer. To achieve this, the velocity sensor 42 is moveable in a direction perpendicular to the surface 2, along the stanchion 310.

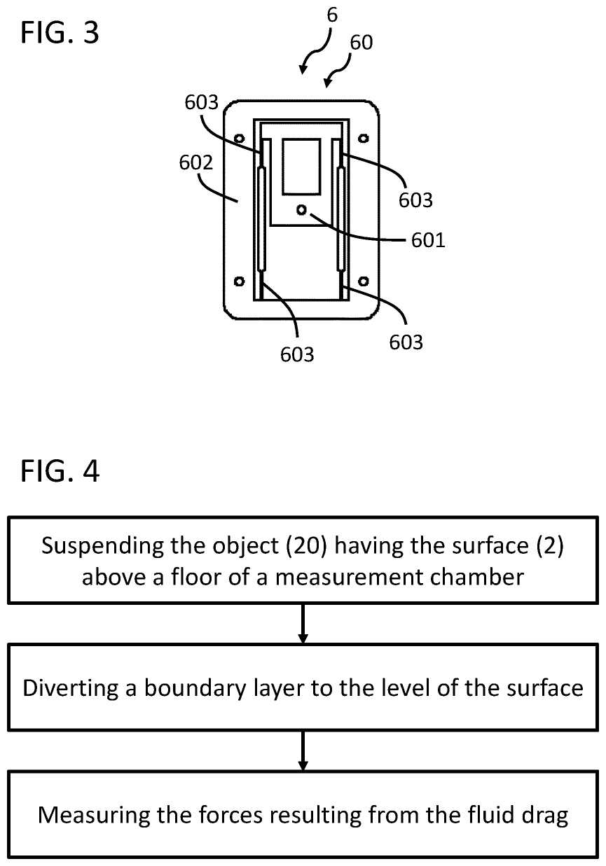

Referring to FIG. 3, an embodiment of the suspension system 6 for suspending the surface 2 is shown. The plan view of the suspension system 6 shows a static body 602 surrounding a support body 601, the static body 602 and the support body 601 being connected by four leaf springs 603. The leaf springs 603 are positioned in two lengths of two leaf springs 603 in series with a thickened material between the two leaf springs 603. The thickened material allows for a higher rigidity in a first direction while the thin leaf springs 603 allow for a higher flexibility in a second direction. Alternatively, the static body 602 and the support body 601 may be connected by means of a single or two leaf springs 603. In principle, any number of leaf springs 603 allows for a functioning suspension system 6.

Referring to FIG. 4, a method for measuring fluid drag exerted by a flow-medium on a surface 2 of an object 20 is shown, the fluid drag being the result of movement of the flow-medium along a direction of said surface 2. The method is shown to comprise the steps of suspending the object 20 having the surface 2 above a floor 11 of a measurement chamber; diverting a boundary layer to the level of the surface 2; and measuring the forces resulting from the fluid drag.

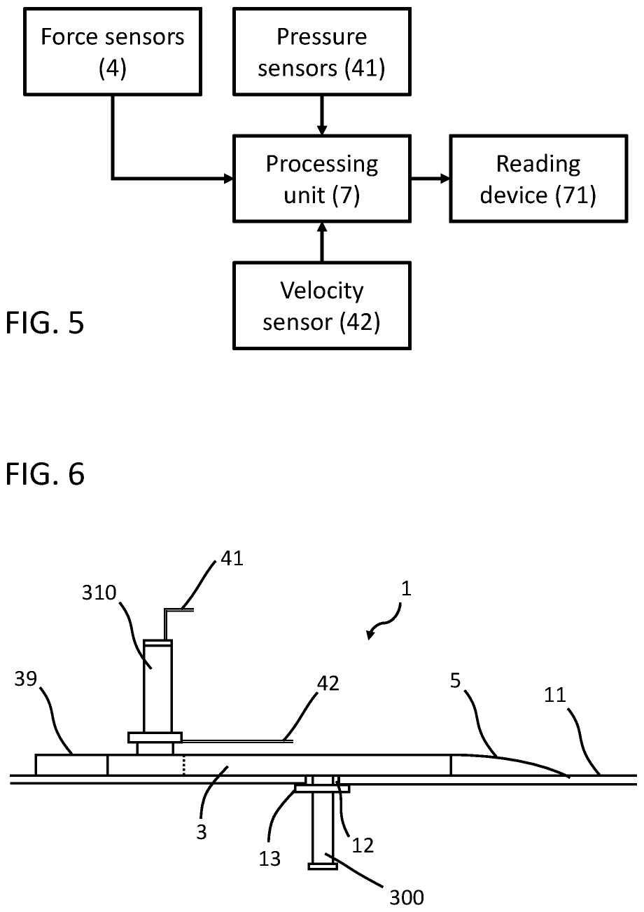

Referring to FIG. 5, a schematic diagram illustrating the processing of measured parameters is shown. The testing device 1 may comprise a processing unit 7 which receives data from one or more from the force sensors 4 and/or the pressure sensors 41 and/or the velocity sensors 42. The processing unit 7 uses this data to determine the fluid drag exerted on the surface 2 and collects information about the circumstances under which said fluid drag was measured such as the pressure and velocity of the flow-medium. The procession unit 7 may optionally send this data to a reading device 71 which depicts the results of the measurement. Alternatively, the processing unit 7 may store said information without transmitting the results to the reading device 71.

Referring to FIG. 6, a side view of an embodiment of the testing device 1 is shown, in relation to the floor or wall 11 of the measurement chamber, the floor or wall 11 having an opening 12. The illustrated embodiment comprises a body 3, coupled to a ramp 5 and a body extension 39. A stanchion 310 having a pressure sensor 41 and a velocity sensor 42 is attached to the body 3 of the testing device 1. The testing device 1 further comprises an anchoring unit 300 traversing through an opening 12 of the wall 11 of the measurement chamber. A gasket 13 ensures a substantially airtight fit between the body 3 of the testing device 1 and the wall 11 of the measurement chamber.

The invention has been described by reference to certain embodiments discussed above. It will be recognized that these embodiments are susceptible to various modifications and alternative forms well known to those of skill in the art.

Further modifications in addition to those described above may be made to the structures and techniques described herein without departing from the spirit and scope of the invention. Accordingly, although specific embodiments have been described, these are examples only and are not limiting upon the scope of the invention.

What is claimed is:

1. A method for measuring fluid drag exerted by a flow-medium on a surface (2) of an object (20), the fluid drag being the result of movement of the flow-medium along said surface (2), the method comprising the steps of:
a. suspending the object (20) within a measurement chamber, and at a distance from a base surface of the measurement chamber;
b. providing a boundary layer of a flowing medium over the surface (2); and
c. measuring at least one force resulting from the fluid drag.

2. The method of claim 1, wherein step c further comprises receiving data from one or more sensors (4) and processing said data.

3. The method of claim 1 or 2, wherein the method further comprises receiving data from at least one pressure sensor (41) and wherein the method preferably further comprises the step of correcting the measurement at step c. based on the data from the at least one pressure sensor (41).

4. The method of any preceding claim, wherein the object (20) is a plate; a sheet; or substantially plate or sheet shaped.

5. The method of any preceding claim, wherein the fluid drag is composed of at least 20%, preferably at least 60%, more preferably at least 80% of skin friction.

6. The method of any preceding claim, wherein step b. comprises diverting a boundary layer of the flowing medium from a base surface of the measurement chamber to the object surface (2), preferably by providing a ramp (500) upstream of the object surface (2).

7. The method of any preceding claim, wherein the base surface of the measurement chamber is absent any recesses or openings for receiving the object upon which fluid drag is measured.

8. The method of any preceding claim, wherein the object (20) is not positioned in a recess or opening in the measurement chamber base surface during steps a. through c.

9. The method of any preceding claim, wherein the measurement chamber is a wind-tunnel.

10. Testing device (1) for measuring fluid drag exerted by a flow-medium on a surface (2) of an object (20), the testing device (1) comprising:
a. a body (3) for retaining the object (20);
b. one or more sensors (4), arranged to measure force exerted on the surface (2); and
c. a flow diverter (5).

11. The testing device (1) of claim 10, wherein the body (3) has a recess for receiving the object (20) such that the surface (2) is substantially flush with a periphery of the recess.

12. The testing device (1) of claim 10 or 11, wherein the height of the body (3) is at most about 20%, preferably at most about 10%, more preferably at most about 5%, even more preferably at most about 3% of the length of the body (3).

13. The testing device (1) of any of claims 10 to 12, wherein the body (3) further comprises a support plate (38) disposed within the body (3) arranged to support the object (20) when placed in the body (3).

14. The testing device (1) of any of claims 10 to 13, wherein the testing device (1) further comprises a flow-medium velocity sensor (42), wherein the velocity sensor (42) preferably is moveable in a direction perpendicular to the surface (2), wherein more preferably, the velocity sensor (42) is attached to a stanchion (310), said stanchion being attached to the upper side of the body (3).

15. The testing device (1) of any of claims 10 to 14, further comprising at least one interbody-surface pressure sensor disposed between the surface (2) and the body, wherein preferably the testing device (1) comprises at least 3, preferably at least 5, more preferably at least 10, even more preferably at least 20 interbody-surface pressure sensors, arranged to measure a pressure profile within the body.

16. The testing device (1) of any of claims 10 to 15, wherein the flow diverter (5) is a ramp (500).

17. The testing device (1) of any of claims 10 to 16, wherein the body (3) further comprises body sides (32, 33), wherein the testing device (1) further comprises at least one lateral flow guide (502, 503) having a side ramp top surface (510) arranged to decrease fluctuations of the boundary layer at the region of the body sides (32, 33).

18. The testing device (1) of any of claims 10 to 17, wherein the testing device (1) further comprises an anchoring unit (300), said anchoring unit (300) being connected to the underside of the body (3), said anchoring unit (300) being arranged to limit the movement of the body (3) relative to a base surface of a measuring chamber.

19. The testing device (1) of any of claims 10 to 18, wherein the ramp is at least partially a super-ellipse in cross-section.

20. The testing device (1) of any of claims 10 to 19, wherein the testing device (1) further comprises a suspension system (6), preferably comprising at least one leaf spring system (60) comprising a support body (601) and a static body (602), the support body (601) and the static body (602) being connected via at least one leaf spring (603).

21. The testing device (1) of any of claims 10-20 further comprising a test object (20) retained by the body (3).

22. A suspension system (6) for the testing device of any of claims 10-21, comprising at least one leaf spring system (60) comprising a support body (601) and a static body (602), the support body (601) and the static body (602) being connected with at least one leaf spring (603), arranged to allow movement in a first direction (604) while limiting movement in a second direction (605), the second direction being perpendicular to the first direction, preferably wherein the first direction (604) coincides with the direction of movement of a flow-medium and wherein the second direction (605) coincides with the direction of gravity.

23. The suspension system (6) of claim 22, connecting one side of the static body (602) with one side of the support body (601), wherein the suspension system (6) preferably couples an object (20) having a surface (2) and a transportation apparatus, wherein the surface (2) of the object forms at least a section of a surface area of said transportation apparatus.

24. A setup for measuring fluid drag exerted by a flow-medium on a surface (2) of an object (20), the fluid drag being the result of movement of the flow-medium along a direction of the surface (2), the setup comprising:
a testing device (1) according to any of claims 10 to 21;
a chamber for supplying a controlled flow of a flow-medium, preferably a wind tunnel.

25. Computer readable medium having computer readable instruction stored thereon that, when executed by a processor of an apparatus according to any of claims 10 to 21 causes the apparatus to measure forces exerted on a surface.

26. A kit of parts for building a testing device (1) according to any of claims 10 to 21, comprising:
a. a body (3) as described in any of claims 10 to 21;
b. one or more force sensors (4) as described in any of claims 10 to 21;
c. a flow-diverter (5) as described in any of claims 10 to 21; and
d. a suspension system (6) as described in any of claims 10 to 23.

27. The kit of parts according to claim 21 wherein the kit of parts further comprises:
a. one or more pressure sensors (41) as described in claims 10 to 21; and/or
b. a processing unit (7); and/or
c. a flow-medium velocity sensor (42); and/or
d. a pressure sensor, preferably a pitot tube.

28. The kit of parts according to claim 27 or 28, wherein the kit of parts has a weight of at most about 500 kg, preferably at most about 300 kg, more preferably at most about 100 kg, still more preferably at most about 50 kg.
